(19) United States
(12) Patent Application Publication
(10) Pub. No.: US 2011/0019712 A1
(43) Pub. Date: Jan. 27, 2011

(54) METHOD FOR OPTIMIZING A FURNACE CAMPAIGN

(76) Inventor: Uwe Geib, Penzberg (DE)

Correspondence Address: 24IP LAW GROUP USA, PLLC, 12 E. LAKE DRIVE, ANNAPOLIS, MD, 21403, US

(21) Appl. No.: 12/933,525

(22) PCT Filed: Mar. 19, 2009
(86) PCT No.: PCT/DE2009/000377

§ 371 Date: Sep. 20, 2010

(30) Foreign Application Priority Data
Mar. 20, 2008 (DE) 10 2008 015 252.8
Jul. 7, 2008 (DE) 10 2008 031 959.7

(51) Int. Cl. F27D 1/00

(52) U.S. Cl. 373/27

(57) ABSTRACT

The invention relates to a method and a device for extending the furnace campaign by avoiding cracks in the stones and the chipping of parts of the stones, and reducing joints in melting furnaces. Said aim is achieved by a measurement of the forces/pressures/moments of the furnace stones occurring against each other, or of the furnace stones against the bracing and defined necessary counter forces, such that the forces between the stones, or between the bracings and the stones are below the maximum permissible compression (pressure force) of the stones, and the forces required for avoiding joints between the stones are ensured. Said process occurs automatically as a form of control by determining the force of sensors, analysis of processors and data, and activation of actuators for generating counter forces.

### FIELD OF THE INVENTION

The invention relates to a method and an apparatus for the prolongation of a furnace campaign by avoiding cracks in stones and chipping/flaking of parts of the stones in a melting furnace.

### INTRODUCTION

This is achieved by keeping the forces, pressures and momentums of the stones used in the melting furnace with respect to each other and/or between the stones of the melting furnace and the anchoring below allowed maximum values, by measuring the forces/pressures/momentums of the stones with respect to each other and/or of the stones against the contact elements of the anchoring, by evaluation of the data and automated slacking or tightening of the pressure elements, in particular when heating up and when cooling down the melting furnace.

### RELATED ART

A furnace of this type is known from the document DE 43 27 237 C1.

Known facilities in the field of glass melting technologies are furnace apparatuses that are assembled from specifically selected fireproof materials. In order to fix the elements in their designated position and in order to take up the considerable forces occurring in some areas, extensive steel constructions are necessary which are summarised by the expression anchoring.

The basis for all anchorings of glass melting ends is a grate of broad flanged beams supported by columns/pillars and longitudinal beams. The cistern/basin of the melting end is mainly made from soldier course and has to be heated up as gap sealing as possible and has to be fixed in a manner that it is not moved apart by the hydrostatic pressure of the glass melt. Round rods are often used which are attached to supporting pillars and which support the basin stones by angular or U-shaped steal. An adjustment can be performed by the round rods that are formed as screw spindles.

Besides the pillars with the support grate, the anchoring of the cistern vault belongs to the most important anchorings of each furnace. The thermal expansion during heating up has to be controlled safely and the vault can only stand a furnace campaign safely if it is free of cracks and has no gaps. It is usually rather accepted to have a pressing in the vault than having a gap that is not closed.

A clear improvement of the vault anchoring was the use of packages of disk springs between anchoring steels and rocking pier. The springs prevent the forces of the vault from rising to unallowed values, even if the anchoring screws are not released in time.

A requirement for a successful heating up is the knowledge of the heat extension of the used fireproof materials taking into account the length change during crystal transformation.

One has to differentiate between load-bearing anchorings with the contact elements which bear a continuous static such as support of the vault, support of single furnace elements, and fixation anchorings with the contact elements. The fixation anchorings solely serve for taking up the heat extensions of the walling during heating up, cooling down and re-heating in order to ensure the stability and gastightness of the walling.

### Object:

Releasing and tightening of the contact elements is performed based on experience and tables. Thereby gaps or unallowed high forces/pressures/momentums can occur at the stones causing cracks in the stones or the chipping/flaking of stone parts which dramatically reduce the durability (furnace campaign) of a glass melting furnace.

It is an object of the invention to provide a method with an adjustment and an apparatus for prolonging a furnace campaign of glass melting furnaces by preventing stones from unallowed high forces/pressures/momentums.

### SUMMARY OF THE INVENTION

The invention provides an apparatus and a method for melting furnaces, in particular for melting glass. Adjustable contact elements between supporting anchorings and stones of the melting furnace and/or between support anchorings and stones of the melting furnace are tightened and/or released. The tightening and/or the releasing of the lateral, double acting hydraulic and/or pneumatic contact elements is performed in a controlled manner according to sensoric determination of individually and locally occurring forces/pressures and e evaluation of the forces/pressures for adaptation of the forces/pressures onto the stones.

Advantages of the invention comprise essentially that the forces/pressures/momentums occurring at the stones always remain within allowed maximum values of the stones. Cracks in the stones and the resulting flaking of parts of the stones caused by unallowed high forces/pressures/momentums on the stones are securely prevented.

Intact Stones provide a higher resistance to chemical reactions and better withstand the mechanical abrasion of the glass. The furnace campaign is thereby substantially prolonged while preventing gaps between the stones.

### DETAILED DESCRIPTION

The invention as defined in claims 1 to 11 and in the dependent claims is related to the object of preventing the occurrence of cracks in the stones (4 to 8) or the flaking of parts of the stones (4 to 8), as well as of gaps between the stones (4 to 8) of the melting furnace, in particular during heating up or cooling down and to thereby allowing a prolonged furnace campaign, by measuring the forces/pressures/momentums between the stones (4 to 8) of the melting furnace and/or between the stones (4 to 8) of the melting furnace and the contact elements (12, 13) of the anchoring (1 to 3), evaluating the measured data and automatically releasing or tightening the contact elements (12, 13) depending on the evaluation of the data.

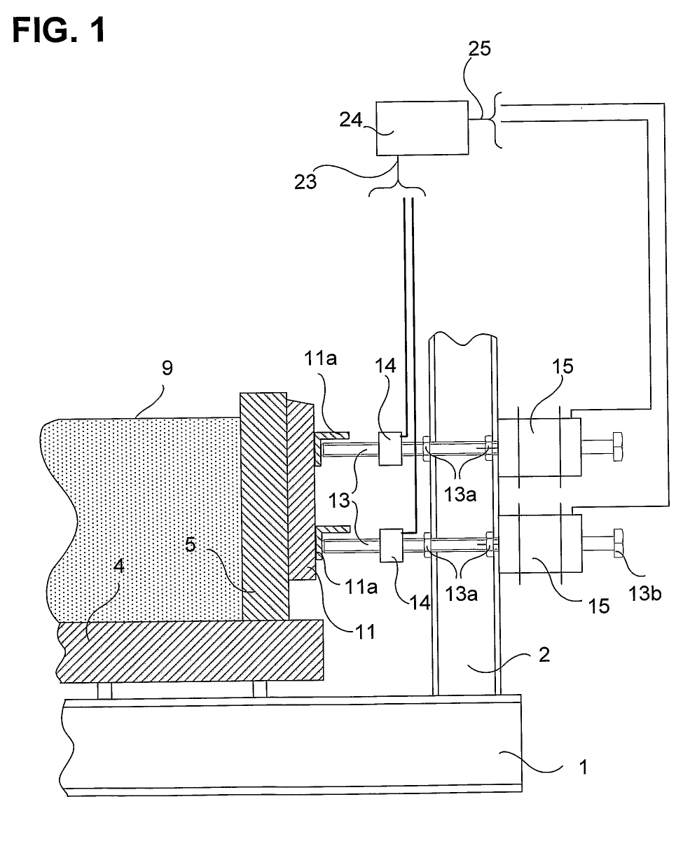

FIG. 1 shows a method according to claim1 and an apparatus according to claim 5 in an example which has been implemented in a way that the control system and the complete apparatus can be implemented in existing furnace designs, for example added for the heating up process.

FIG. 1 shows a section of a cross section through a furnace volume; the hydrostatic pressure which is applied by the glass melt (9) to the side wall of the melting end (5) via the bridge wall (11) with the resting elements (11a) on the pressure element, which is in this case implemented as leading screw (13), is transmitted via a guide thread of the leading screw (13a) to the side anchoring (2).

The force/pressure exercised onto the leading screw (13) is measured via force/pressure sensors (14) and the obtained data are transferred to an data evaluation and control unit (24) via a control line of the sensors (23) and the results of the evaluation are forwarded as control pulses via control lines of actuators (24) to the motor driven actuators (15) in order to thereby perform an axial movement of the leading screw (13) around the screw axis, wherein the force/pressure exercised on the leading screw (13) is changed thereby ensuring that limit values of the material data of the stones (4 to 8) is observed, such that the occurrence of cracks in the stones (4 to 8) and/or the flaking of parts of the stones (4 to 8) of the melting furnace caused by unallowed high pressing of the stones is prevented and gaps are prevented by observing minimum values.

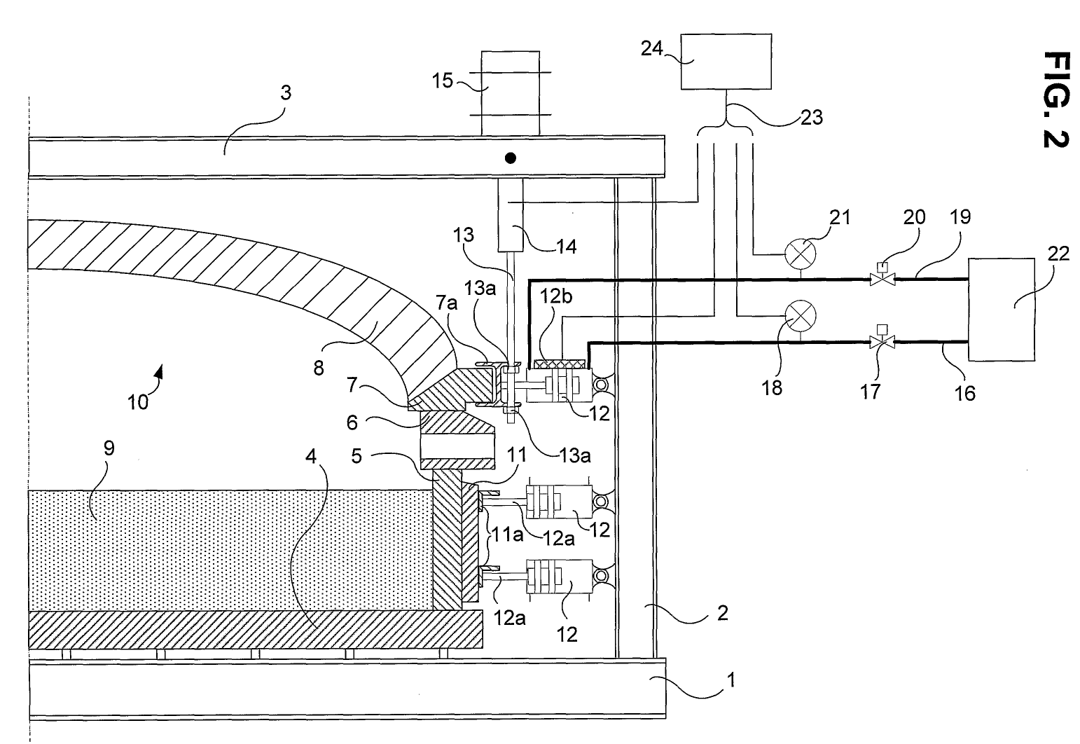

A further method of an example according to FIG. 2 can be implemented in a manner that the leveler and the complete apparatus remain during the complete furnace campaign and form parts of the furnace.

FIG. 2 shows a partial section through the furnace volume; the hydrostatic pressure which is exercised by the glass melt (9) onto the side wall of the melting end (5), via the bridge wall (11) with resting units (11a) on the pressure elements (12, 13), the piston rod (12a) of the hydraulic cylinder (12), which also can be implemented by corresponding alternatives known to a person skilled in the art, i.e. pneumatic or other hydrostatic pressure elements which are connected to the anchoring of the side (2), generates a pressure in the hydraulic cylinder (12) which is transferred via hydraulic line-A (16).

The pressure exercised on the hydraulic cylinder (12) is determined via a pressure sensor-A (18) and the data are transferred via the control line of the sensors (23) to the data evaluation and control unit (24), the results of the evaluation are forwarded as control signals/pulses via the control lines of the actuators (24) towards pressure regulation valves-A (17), which are supplied via hydraulic line-A (16) by the hydraulically adjustable pressure generation with switching logics (22) with corresponding pressurised hydraulic liquid in order to perform an axial displacement of the piston rod (12a) of the hydraulic cylinder (12) by which the pressure exercised on the hydraulic cylinder (12) is changed thereby ensuring the observance of the limit values of material data of the stones (4 to 8) by the control system. The vault (8), which is arranged in a self-supporting manner, is supported by a vault skewback (7) with an intermediate support (7a) at the leading screw (13), the description of the example has been described earlier in the description, the weight of the vault (8) and the related surface pressure on the nozzle brick (6) can be limited by the method and the apparatus and can be adjusted without forming gaps. Besides a selection of certain anchorings (1 to 3) or the equipment of all anchorings (1 to 3) for the automatic controlled releasing or tightening of the pressure elements (12, 13), there is the possibility of a timely limitation, for example for the heating up as shown in FIG. 1, as well as the continuous implementation of the method and the apparatus as part of the furnace.

The use of further values that can be measured such as the temperature in, at and around the furnace or the stones (4 to 8), the chemical composition of the exhaust gases and/or of the melt as well as further data from the pressure transfer medium such as, for example, hydraulic liquid, pressurised air, of the used materials and the environment in the evaluation for control of the pressure elements (12, 13) provides additional possibilities for a more precise control and is also applicable in emergency cases, for example in an automated start of a cooling down process without damaging the furnace elements or can indicate a premature wear of elements or the exciding of limit values based on data anomalie. It is obvious to a person skilled in the art that the determination of data as well as the evaluation of data and the transmission of the result events is possible in an analogue or in a digital format, the switching can be implemented as a web, in sections or in a singular mode.

It is known to person skilled in the art of hydraulics/pneumatics that not all hydraulic/pneumatic cylinders have to be driven by a single pressure generation element but can be grouped together with corresponding control elements. It can be advantageous in some cases to assign one pressure generation element to each pressure element.

The use of tensile forces and pressure forces of pressure elements (12, 13) with respect to the stones (4 to 8) enables a translational movement in a specific direction and backwards, wherein some stones (4 to 8) or sections become barriers for enforcing a glass current in a glass bath (9) or whirls and pressure adjustment possibilities in the upper part of the furnace (10) or adjustment of the exhaust pressure by changing the cross section of the aperture for the exhaust gases from the furnace.

FIG. 2 shows the possibility of a controlled translational movement of the pressure elements (12, 13), in this case the piston rod (12a) using a hydraulic line-B (19), a pressure regulation valve-B (20) and a pressure sensor-B (21), the function of which is explained earlier in the description with respect to the hydraulic line-A (16), and advantageously with a distance measurement by a distance transmitter (12b), which can be, in case of a leading screw (13), a turn transmitter with and is advantageously, wherein a translational movement of the stones (4 to 8) is enabled by the adjustment of the pressure elements (12, 13) via a known connection between the stones (4 to 8) and the pressure elements (12, 13).

The claims are not limited to melting of glass, other areas of manufacturing glass such as purging or refining and homogenisation as well as areas of metal melting and mineral smelting form part of the claimed invention.

### REFERENCE SIGNS

1. anchoring of the base
2. anchoring of the side
3. anchoring of the ceiling
4. basis of the melting end/basin
5. sidewall of the melting end/basin
6. nozzle brick
7. vault skewback
7a. intermediate support
8. vault
9. glass bath
10. upper part of the furnace
11. bridge wall
11a. resting element
12. hydraulic cylinder
12a. piston rod of the hydraulic cylinder
12b. distance measuring unit
13. leading screw
13a. guiding thread of the leading screw
13b. head of the leading screw; for manual adjustment
14. force/pressure sensor(s)
15. motor driven actuator
16. hydraulic line-A
17. pressure regulation valve-A
18. pressure sensor-A
19. hydraulic line-B
20. pressure regulation valve-B
21. pressure sensor-B
22. hydraulic pressure generation with switching logic
23. control line for the sensors
24. data evaluation and control unit
25. control line of the actuators

1-7. (canceled)

8. A method for melting furnaces, in particular for melting glass, the method comprising:
tightening or releasing adjustable contact elements between supporting anchorings and stones of the melting furnace and/or between support anchorings and stones of the melting furnace;
wherein the tightening and/or the releasing of the lateral, double acting hydraulic and/or pneumatic contact elements is performed in a controlled manner comprising:
sensorically determining individually and locally occurring forces or pressures; and
evaluating the forces or the pressures for an adaptation of the forces or pressures onto the stones.

9. The method of claim 8, wherein the forces or pressures or an momentum between the stones is determined using sensors.

10. The method of claim 8, wherein at least one of the temperature in, at and around the furnace or in, at and around the stones, the chemical composition of exhaust gases and of the melt, further data of a pressure transmission medium, of used materials and an environment are considered in the evaluation.

11. The method of claim 8, wherein values are determined indirectly using at least one distance or gap measurement.

12. An apparatus for melting furnaces, in particular for glass melting, the apparatus comprising:
adjustable contact elements between supporting anchorings and stones of the melting furnace and/or between support anchorings and stones of the melting furnace which are tightened and/or released,
wherein the tightening and/or the releasing of the lateral, double acting hydraulic and/or pneumatic contact elements is performed in a controlled manner according to a sensoric determination of individually and locally occurring at least one of forces, pressures and momentums and evaluation of the at least one of the forces, the pressures and the momentums for adaptation of the at least one of the forces, the pressures and the momentums onto the stones and by an automatic adjustment of the contact elements via the corresponding drive.

13. The apparatus of claim 12, wherein a hydrostatic pressure is generated between the stones of the melting furnace and the anchoring.

14. The apparatus of claims 12, wherein the contact elements move the stones of the melting furnace into a desired direction by the double acting, hydraulic or pneumatic elements.
